(19) United States
(12) Patent Application Publication
(10) Pub. No.: US 2016/0231975 A1
(43) Pub. Date: Aug. 11, 2016

(54) CONTENT COMPOSING DEVICE AND METHOD OF COMPOSING CONTENT

(71) Applicant: SAMSUNG ELECTRONICS CO., LTD., Suwon-si (KR)

(72) Inventors: Dong-wook KIM, Suwon-si (KR); Hye-hyun HEO, Seoul (KR); Nam-kyun BEON, Seoul (KR)

(21) Appl. No.: 14/931,077

(22) Filed: Nov. 3, 2015

(30) Foreign Application Priority Data
Feb. 11, 2015 (KR) 10-2015-0020967

(51) Int. Cl. G06F 3/14; G09G 5/02; G09G 5/10

(52) U.S. Cl. CPC G06F 3/1446; G09G 5/10; G09G 5/02; G09G 2320/0626; G09G 2320/0666; G09G 2356/00; G09G 2320/10; G09G 2320/029

(57) ABSTRACT

Methods of composing content to be displayed on a plurality of display apparatuses are disclosed. An example method includes obtaining arrangement information of the display apparatuses from a captured image of the display apparatuses that display the content; determining content to be displayed on each of the display apparatuses based on the obtained arrangement information; and transmitting the content determined with respect to the display apparatuses to the display apparatuses.

### CROSS-REFERENCE TO RELATED APPLICATION

This application is based on and claims priority under 35 U.S.C. §119 to Korean Patent Application No. 10-2015-0020967, filed on Feb. 11, 2015, in the Korean Intellectual Property Office, the disclosure of which is incorporated by reference herein in its entirety.

### BACKGROUND

1. Field

The disclosure relates to content composing devices and methods of composing content.

2. Description of Related Art

For the purposes of advertisement and information transmission, advertisers, product providers, and service providers prefer a video wall that may effectively transfer information about products and services to customers through a digital display apparatus.

In the related art, input items of content are composed according to locations and configurations of the video wall. Therefore, when the locations and the configurations are changed, the input items of content need to be composed and the display state of the video wall is degraded as time passes, and thus, readability and aesthetic impression of the display are reduced.

### SUMMARY

Provided are example content composing devices that obtain location information and attribute information of a plurality of display apparatuses by using photographing devices or sensors, and automatically compose content to be displayed on the display apparatuses based on the obtained information, and methods of composing content.

Additional aspects will be set forth in part in the description which follows and, in part, will be apparent from the description.

According to an aspect of an example, a method of composing content to be displayed on a plurality of display apparatuses is provided. The method includes: obtaining arrangement information of the display apparatuses from a captured image of the display apparatuses that display the content; determining content to be displayed on each of the display apparatuses based on the obtained arrangement information; and transmitting the content determined with respect to the display apparatuses to the display apparatuses.

The method may further include receiving the captured image of the display apparatuses from an external device.

The method may further include: obtaining display attribute information of the display apparatuses from a captured image of the display apparatuses; and controlling the display apparatuses so that brightness and color of the display apparatuses are corrected based on the display attribute information of the display apparatuses.

The method may further include arrangement information of the display apparatuses from sensors associated with each of the display apparatuses.

The arrangement information may include at least one of numbers, shapes, sizes, connection structures, locations, perspectives, inclinations, and separation distances of the display apparatuses.

Obtaining the arrangement information of the display apparatuses may include correcting an image distortion based on a photographing location and perspective with respect to the captured image.

The display attribute information of the display apparatuses may include at least one of brightness information and color information of the display apparatuses.

The method may further include: receiving photographing information about the presence of users; and controlling the display apparatuses so that brightness and color of the display apparatuses are corrected based on the display attribute information of the display apparatuses based on the received information.

The method may further include controlling each of the display apparatuses to periodically correct the brightness and color of the display apparatuses at predetermined times.

According to an aspect of an example, a content composing device that composes content to be displayed on display apparatuses is provided. The content composing device includes: a processor configured to obtain arrangement information of the display apparatuses from a captured image of the display apparatuses that display the content and to determine the content to be displayed on each of the display apparatuses based on the obtained arrangement information; and communication circuitry configured to transmit the content determined with respect to the display apparatuses to each of the display apparatuses.

The communication circuitry may be in the form of a communication interface that may receive a captured image of the display apparatuses from an external device.

The processor may be configured to obtain display attribute information of the display apparatuses from the captured image of the display apparatuses, and may be configured to control the display apparatuses so that brightness and color of the display apparatuses are corrected based on the display attribute information of the display apparatuses.

The communication interface may receive arrangement information of the display apparatuses from sensors associated with the display apparatuses.

The arrangement information may include at least one of numbers, shapes, sizes, connection structures, locations, perspectives, inclinations, and separation distances of the display apparatuses.

The processor may be configured to correct an image distortion based on photographing location and perspective with respect to the captured image of the display apparatuses.

The display attribute information of the display apparatuses may include at least one of brightness information and color information of the display apparatuses.

The communication interface may receive photographing information with respect to the existence of users, and the processor may be configured to control the display apparatuses so that brightness and color of the display apparatuses are corrected based on the display attribute information of the display apparatuses based on the received information.

The processor may be configured to control each of the display apparatuses to periodically correct the brightness and color of the display apparatuses at predetermined times.

According to an aspect of an example, a computer readable recording medium on which a program for realizing the method of composing the content described above is realized.

### BRIEF DESCRIPTION OF THE DRAWINGS

These and/or other aspects will become apparent and appreciated from the following detailed description, taken in conjunction with the accompanying drawings in which like reference numerals refer to like elements, and wherein:

FIG. 1 is a drawing illustrating an example video wall;

FIGS. 2A, 2B, and 2C respectively are illustrations of example video walls;

FIG. 3 is a block diagram illustrating an example content composing device;

FIG. 4 is a block diagram illustrating an example content composing device;

FIG. 5 is a flowchart illustrating an example method of composing content;

FIG. 6 is a schematic diagram illustrating an example flow of information based on a content composing device;

FIG. 7 is a flowchart illustrating an example method of installing a video wall;

FIG. 8 is a flowchart illustrating an example method of installing a video wall;

FIG. 9 is a block diagram illustrating an example process of receiving information from a photographing device and a sensor;

FIG. 10 is a drawing illustrating an example of gaining separation distances between display apparatuses;

FIG. 11 is a schematic drawing illustrating an example correction of image distortion according to photographing locations of a captured image by a content composing device;

FIGS. 12A, 12B, and 12C are drawings for explaining the generation of perspective distortion of an image, according to an example;

FIG. 13 is a flowchart illustrating an example method of composing content;

FIG. 14 is a flowchart illustrating an example method of obtaining information with respect to locations of display apparatuses;

FIG. 15 is a flowchart illustrating an example method of determining content to be displayed on the display apparatuses;

FIGS. 16A and 16B are drawings illustrating examples of correcting brightness and color of content; and

FIG. 17 is schematic drawing illustrating an example of obtaining information of users through a photographing device.

### DETAILED DESCRIPTION

Reference will now be made in detail to example embodiments, examples of which are illustrated in the accompanying drawings. The examples may, however, be embodied in many different forms and should not construed as limited to the examples set forth herein. Rather, these examples are provided so that this disclosure will convey the scope of the disclosure to those of ordinary skill in the art. The examples will be defined by the appended claims.

Terminologies used in the disclosure will be briefly described and the examples will be described in detail.

Terminologies used herein are selected as commonly used by those of ordinary skill in the art in consideration of functions of the examples, but may vary according to the technical intention, precedents, or a disclosure of a new technology. Also, in particular cases, some terms are arbitrarily selected by the applicant, and in this case, the meanings of the terms will be described in detail at corresponding parts of the specification. Accordingly, the terms used in the disclosure should be defined not by simply the names of the terms but based on the meaning and contents of the whole specification.

It should be understood that, when a part “comprises” or “includes” an element in the disclosure, unless otherwise defined, it does not exclude other elements but may further include other elements. Also, in the disclosure, the term “units” denote hardware constitution elements, such as, circuitry, software, a field programmable gate array (FPGA), or an application specific integrated circuit (ASIC), or any combination thereof, and the “units” perform functions. However, the meaning of “units” is not limited to software of hardware. The “units” may be configured to be in an addressable storage medium or may be configured to re-produce one or more processors. Accordingly, as an example, the “units” includes constituent elements, such as hardware constituent elements, software constituent elements, object-oriented software constituent elements, class constituent elements, and task constituent elements, segments of processes, functions, attributes, procedures, sub-routines, and program codes, drivers, firmware, micro codes, circuits, data, databases, data structures, tables, arrays, and variables. Functions provided in the constituent elements and the “units” may be combined with a further smaller number of constituent elements and “units” or may further be divided into additional constituent elements and “units”.

In the examples, a mobile device denotes a computer device of a relatively small size that may be portable by the user, for example, mobile phones, personal digital assistants (PDAs), and notebooks.

Reference will now be made in detail to examples, examples of which are illustrated in the accompanying drawings so that those of ordinary skill in the art may readily understand. In the drawings, portions irrelevant to the description are omitted for convenience of explanation.

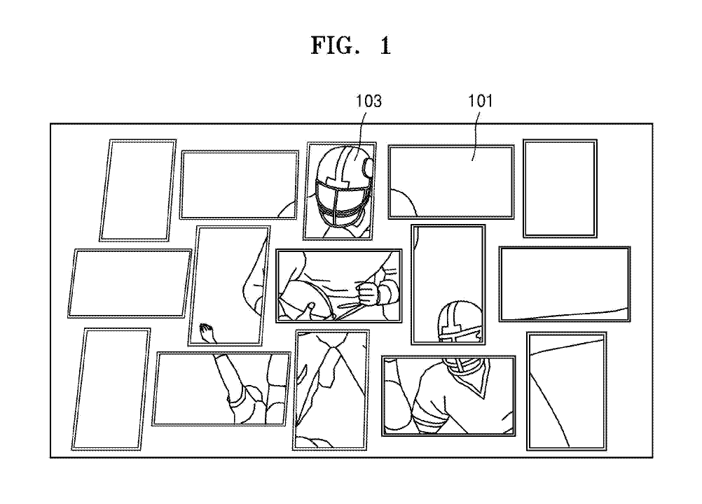

FIG. 1 is a drawing illustrating an example video wall.

In the disclosure, a video wall may, for example, denote a plurality of display apparatuses that are connected to each other to show a portion of whole content or to repeatedly show the same content. Of course, the display apparatuses of the video wall may display different items of content from each other.

For example, FIG. 1 shows a video wall that includes 15 display apparatuses 101 connected to each other and each of the display apparatuses 101 displays a divided upper body image 103 of a man who carries a football.

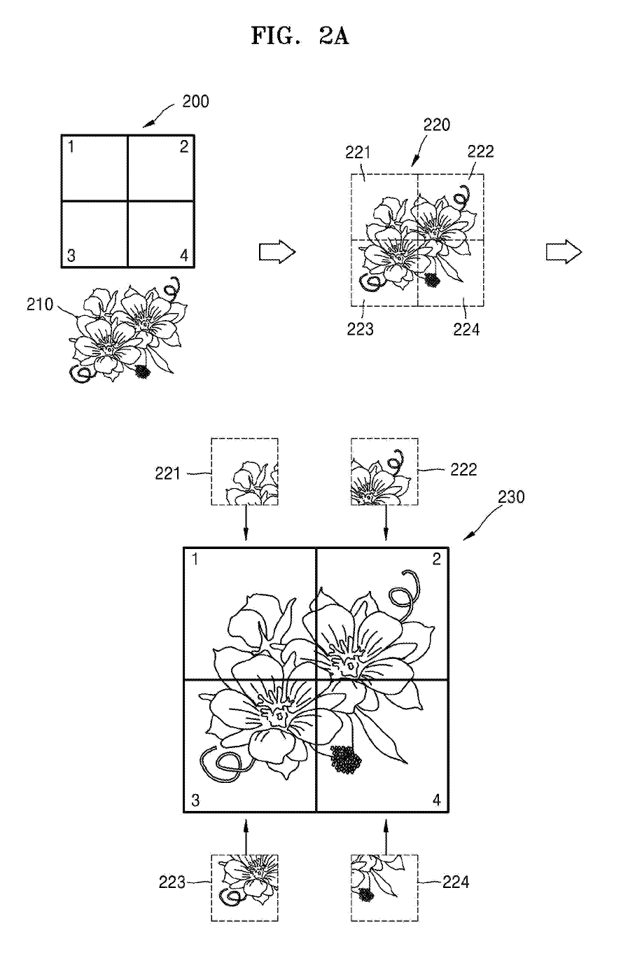

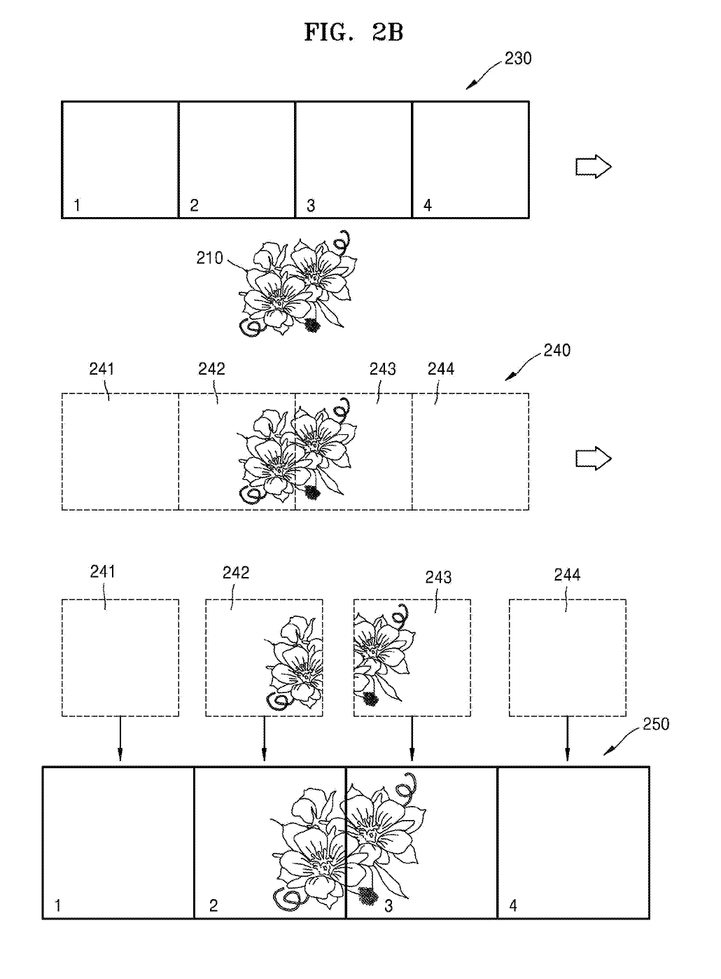

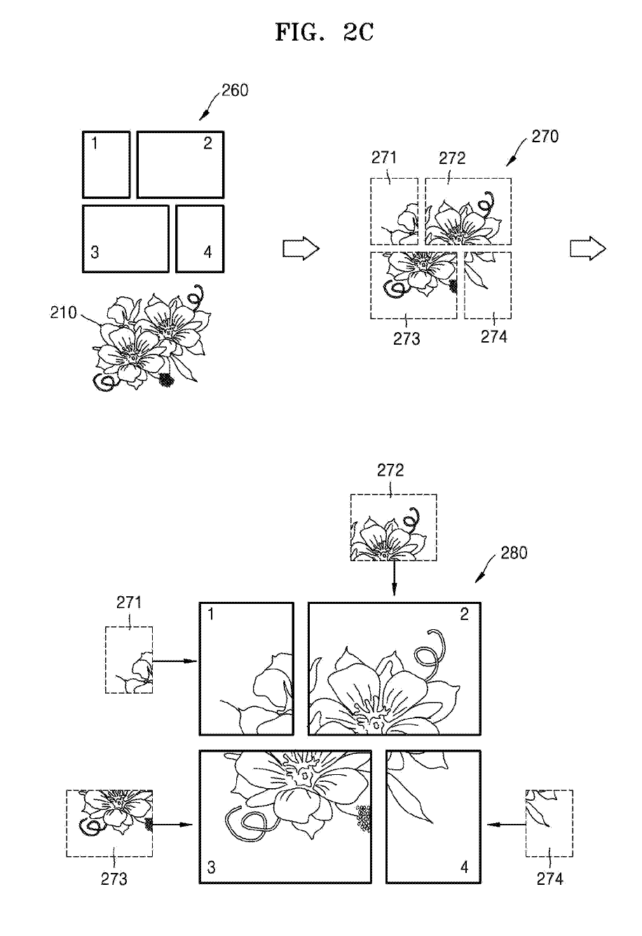

FIGS. 2A, 2B, and 2C respectively are examples of video walls.

FIG. 2A is a schematic drawing of an example video wall in which each of the display apparatuses displays a portion of content 210 by connecting the four display apparatuses 1, 2, 3, and 4 each having the same size in a square shape.

Referring to FIG. 2A, a content composing device according to an example may determine the contents to be displayed on each of the display apparatuses 1, 2, 3, and 4 using arrangement information 200 of the display apparatuses 1, 2, 3, and 4. According to the arrangement information 200 of the display apparatuses 1, 2, 3, and 4, for example, the information that indicates the display apparatuses 1, 2, 3, and 4 each having the same size and the same shape are arranged in a square shape, the content composing device disposes the content 210 to match with the layout 220 of the display apparatuses 1, 2, 3, and 4 that are arranged in a square shape, and determines contents to be displayed on each of the display apparatuses 1, 2, 3, and 4. The content composing device may determine the display device 1 to display a left-upper part 221 of the content 210, the display device 2 to display a right-upper part 222 of the content 210, the display device 3 to display a left-lower part 223 of the content 210, and the display device 4 to display a right-lower part 224 of the content 210. When the determination is completed, the content composing device may transmit the left-upper part 221 of the content 210 to the display device 1, the right-upper part 222 of the content 210 to the display device 2, the left-lower part 223 of the content 210 to the display device 3, and the right-lower part 224 of the content 210 to the display device 4. Thus, the content 210 may be displayed on the display apparatuses 1, 2, 3, and 4 (230) in collaboration with each other.

FIG. 2B is a schematic drawing of an example video wall in which each of the display apparatuses displays a portion of the content 210 by connecting the four display apparatuses 1, 2, 3, and 4 each having the same size in a series.

Referring to FIG. 2B, the content composing device according to the example may determine the content 210 to be displayed on each of the display apparatuses 1, 2, 3, and 4 using arrangement information 230 of the display apparatuses 1, 2, 3, and 4. According to the arrangement information 230 of the display apparatuses 1, 2, 3, and 4, for example, the information that indicates the display apparatuses 1, 2, 3, and 4 each having the same size and the same shape are horizontally arranged in series, the content composing device disposes the content 210 to match with the layout 240 of the display apparatuses 1, 2, 3, and 4 that are arranged in series, and determines the contents to be displayed on each of the display apparatuses 1, 2, 3, and 4. The content composing device may determine the display device 1 to display an empty image 241, the display device 2 to display a left-half part 242 of the content 210, the display device 3 to display a right-half part 243 of the content 210, and the display device 4 to display an empty image 244 of the content 210. When the determination is completed, the content composing device may transmit the empty image 241 of the content 210 to the display device 1, the left-half part 242 of the content 210 to the display device 2, the right-half part 243 of the content 210 to the display device 3, and the empty image 244 of the content 210 to the display device 4. Thus, the content 210 may be displayed on the display apparatuses 1, 2, 3, and 4 (250) in collaboration with each other.

FIG. 2C is a schematic drawing illustrating an example video wall in which each of the display apparatuses displays a portion of the content 210 by connecting the four display apparatuses 1, 2, 3, and 4 having different sizes and shapes from each other.

Referring to FIG. 2C, the content composing device according to the example may determine the content 210 to be displayed on each of the display apparatuses 1, 2, 3, and 4 using arrangement information 260 of the arrangement of the display apparatuses 1, 2, 3, and 4 that display the content 210. According to the arrangement information 260 of the display apparatuses 1, 2, 3, and 4, for example, the information that indicates how the display apparatuses 1, 2, 3, and 4 having different sizes and different shapes are arranged, the content composing device disposes the content 210 to match the layout 270 of the arranged display apparatuses 1, 2, 3, and 4, and determines the content to be displayed on each of the display apparatuses 1, 2, 3, and 4. The content composing device may determine the display device 1 to display a left-upper part 271 of the content 210, the display device 2 to display a right-upper part 272 of the content 210, the display device 3 to display a left-lower part 273 of the content 210, and the display device 4 to display a right-lower part 274 of the content 210. When the determination is completed, the content composing device may transmit the left-upper part 271 of the content 210 to the display device 1, the right-upper part 272 of the content 210 to the display device 2, the left-lower part 273 of the content 210 to the display device 3, and the right-lower part 274 of the content 210 to the display device 4. Thus, the content 210 may be displayed on the display apparatuses 1, 2, 3, and 4 (280) in collaboration with each other.

FIGS. 2A, 2B, and 2C indicate that the same numbers of display apparatuses display the same content 210, but, according to arrangement information, such as shape, size, connection structure, and separation distance of the display apparatuses, the content to be displayed on the display apparatuses may be changed.

For example, in FIG. 2A, all of the display apparatuses 1, 2, 3, and 4 display parts of the content 210. However, in FIG. 2, the display apparatuses 1 and 4 do not display the content 210 but the display apparatuses 2 and 3 respectively display parts of the content 210.

A content composing method and a content composing device according to an example will be described below. In the content composing method, content to be displayed on display apparatuses are automatically determined by obtaining arrangement information, such as the numbers, shapes and sizes, connection structures, and separation distances of the display apparatuses.

Also, a content composing method and a content composing device, by which contents may be uniformly displayed by compensating brightness and colors of display apparatuses based on captured images obtained by the display apparatuses or pre-information of the display apparatuses, are described below.

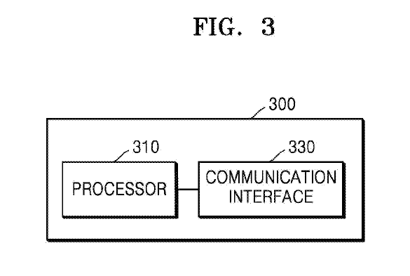

FIG. 3 is a block diagram illustrating an example content composing device 300.

The content composing device 300 may include a processor 310 and communication circuitry in the form of a communication interface 330.

The communication interface 330 may receive images of a plurality of display apparatuses that will display content from an external photographing device (not shown) that photographs the display apparatuses.

The processor 310 may be configured to obtain arrangement information of a plurality of the display apparatuses, and may be configured to determine content to be displayed on each of the display apparatuses based on the obtained arrangement information. The processor 310 may be configured to control overall operation of the content composing device 300 and may be configured to process various data required for operating the content composing device 300. The processor 310 may, for example, include a central processor (CPU), a micro-processor, or a graphic processor (GPU).

The arrangement information of the display apparatuses may, for example, be obtained through images of the display apparatuses that are received from the communication interface 330, through sensors mounted on the display apparatuses, or through other methods.

The communication interface 330 may transmit content determined with respect to the display apparatuses to the display apparatuses.

The processor 310 and the communication interface 330 according to the example are configured as separate constituent elements. However, according to another example, the processor 310 and the communication interface 330 may be realized as a single constituent element by being combined with each other.

Also, in the current example, it is depicted that the processor 310 and the communication interface 330 are shown as constituent elements located close to each other in the content composing device 300. However, devices that function as the processor 310 and the communication interface 330 may not necessarily be physically adjacent to each other, and the processor 310 and the communication interface 330 may be separated from each other.

Also, the content composing device 300 is not limited to a physical device, and thus, some functions of the content composing device 300 may be realized by using software rather than hardware.

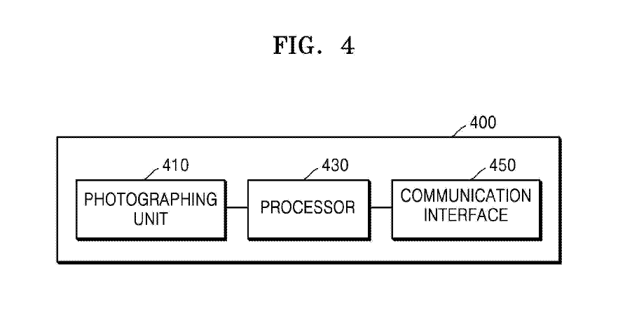

FIG. 4 is a block diagram illustrating an example content composing device 400.

As depicted in FIG. 4, the content composing device 300 may receive a captured image from a photographing device as an additional device different from the photographing device. However, the content composing device 300 may further include a photographing unit therein.

For example, the content composing device 400 may include a photographing unit 410, a processor 430, and communication circuitry in the form of a communication interface 450.

The photographing unit 410 may be configured to take photos of the display apparatuses which will display content and may transmit the captured image to the processor 430.

The processor 430 may be configured to obtain arrangement information of each of the display apparatuses through the received images, and may be configured to determine the content to be displayed on each of the display apparatuses based on the obtained arrangement information. The processor 430 may be configured to control overall operation of the content composing device 400 and may be configured to process various data required for operating the content composing device 400. The processor 430 may, for example, include a CPU, a micro-processor, a GPU, etc. The communication interface 450 may transmit content determined with respect to the display apparatuses to each of the display apparatuses.

In the current example, the photographing unit 410, the processor 430, and the communication interface 450 are expressed as separate units. However, in another example, the photographing unit 410, the processor 430, and the communication interface 450 may be realized as a single constituent unit by being combined with each other.

Also, in the current example, the photographing unit 410, the processor 430, and the communication interface 450 are expressed as constituent units located adjacently to each other in the content composing device 400. Devices that perform the functions of the photographing unit 410, the processor 430, and the communication interface 450 may not necessarily be physically adjacent to each other, that is, the photographing unit 410, the processor 430, and the communication interface 450 may be separated from each other.

Also, the content composing device 400 is not limited to a physical device, and thus, some functions of the content composing device 400 may be realized using software rather than hardware.

In the current example, the content composing device 400 may further include a display unit. The display unit may include display apparatuses that display some of the content or the whole content received from a processor that determines the content to be displayed on the display apparatuses.

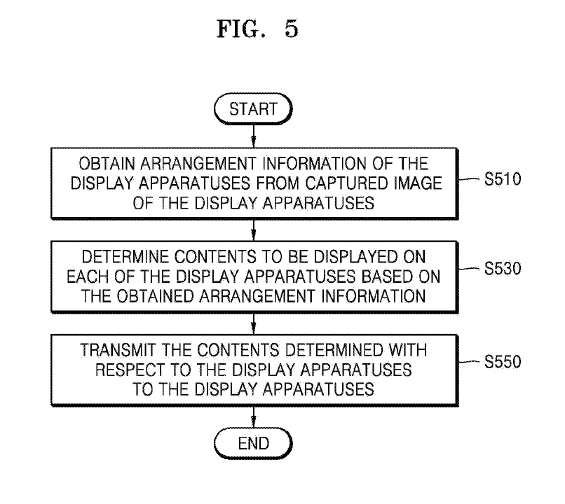

FIG. 5 is a flowchart illustrating an example method of composing content.

In operation S510, the content composing device 300 may obtain arrangement information of display apparatuses from an image of the display apparatuses.

The image of the display apparatuses may be a single image on which all the display apparatuses that constitute a video wall are captured.

The arrangement information of the display apparatuses may include at least one of the numbers, shapes and sizes, connection structures, locations, distances, inclinations, and separation distances of the display apparatuses.

The arrangement information of the display apparatuses may be obtained from an image of a video wall that is captured by a photographing device, such as a camera or a CCTV, from a sensor attached to each of the display apparatuses, or from other methods.

A process of obtaining arrangement information of the display apparatuses will be described in detail below.

In operation S530, the content composing device 300 may determine contents to be displayed on each of the display apparatuses based on the obtained information.

A video wall may repeatedly display the same contents, but each of the display apparatuses may display a part of the whole content. In the case of a video wall in which each of the display apparatuses displays a part of the whole content, a process of determining contents to be displayed on each of the display apparatuses may be necessary since the display apparatuses display the contents by dividing the contents.

The contents to be displayed on each of the display apparatuses may be automatically determined based on the arrangement information of the display apparatuses.

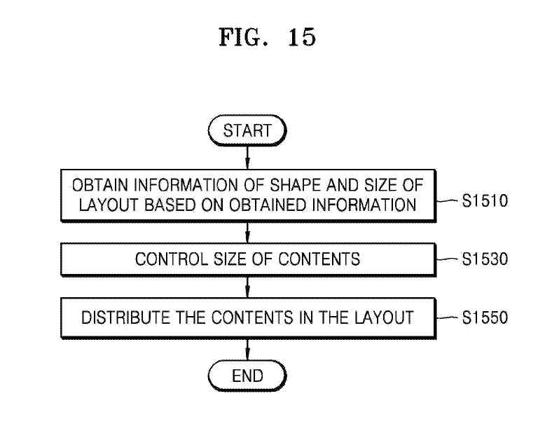

A detailed process for determining the contents to be displayed on each of the display apparatuses will be described below with reference to FIG. 15.

In operation S550, the content composing device 300 may transmit the generated contents to each of the display apparatuses.

The content composing device 300 may transmit the generated contents to each of the display apparatuses through a wired or wireless communication network.

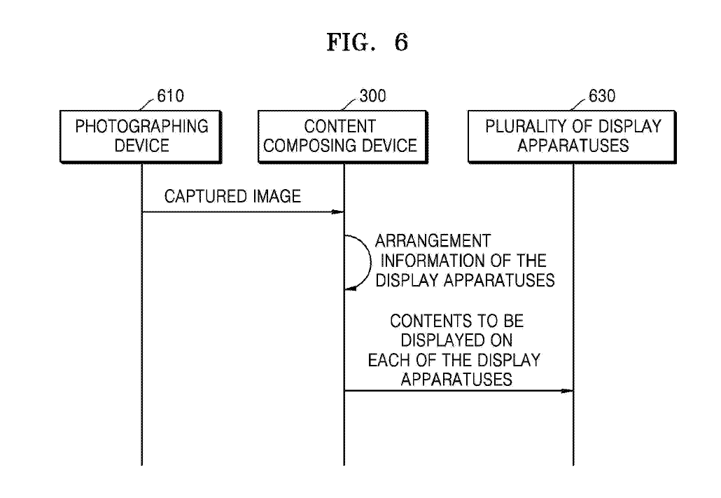

FIG. 6 is a schematic diagram illustrating an example flow of information based on the content composing device 300.

A photographing device 610 may transmit an image of a video wall to the content composing device 300.

According to an example, the photographing device 610 and the content composing device 300 may constitute a single device in which they are not physically separated from each other.

The content composing device 300 may obtain arrangement information of a plurality of display apparatuses based on a received image. The content composing device 300 may determine contents to be displayed on each of the display apparatuses 630 based on the obtained arrangement information of the display apparatuses.

The content composing device 300 may transmit the determined contents to be displayed on each of the display apparatuses 630 to each of the display apparatuses 630.

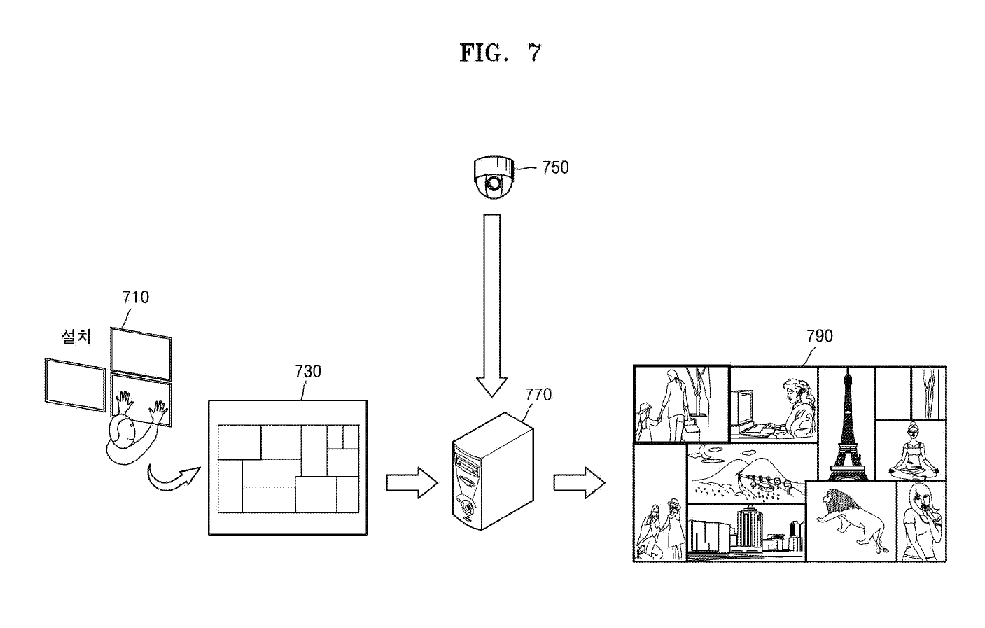

FIG. 7 is a flowchart illustrating an example method of installing a video wall.

In the related art, after generating contents to be displayed on each of the display apparatuses of the video wall, the video wall is installed based on the generated contents.

In the current example, the method of installing a video wall includes: installing the video wall 710 and 730; obtaining arrangement information 770 of display apparatuses by photographing 750 the video wall; configuring contents 770 based on the obtained information; and transmitting the composed contents 790 to each of the display apparatuses.

When the same content is provided to various types of video walls, the contents is automatically composed based on the types of the video walls although the contents to be displayed on each of the display apparatuses are not generated based on the types of the video walls. Thus, convenience and efficiency of installing the video wall is increased.

Also, when the arrangement of the video wall is changed, the contents to be displayed on each of the display apparatuses may be readily generated.

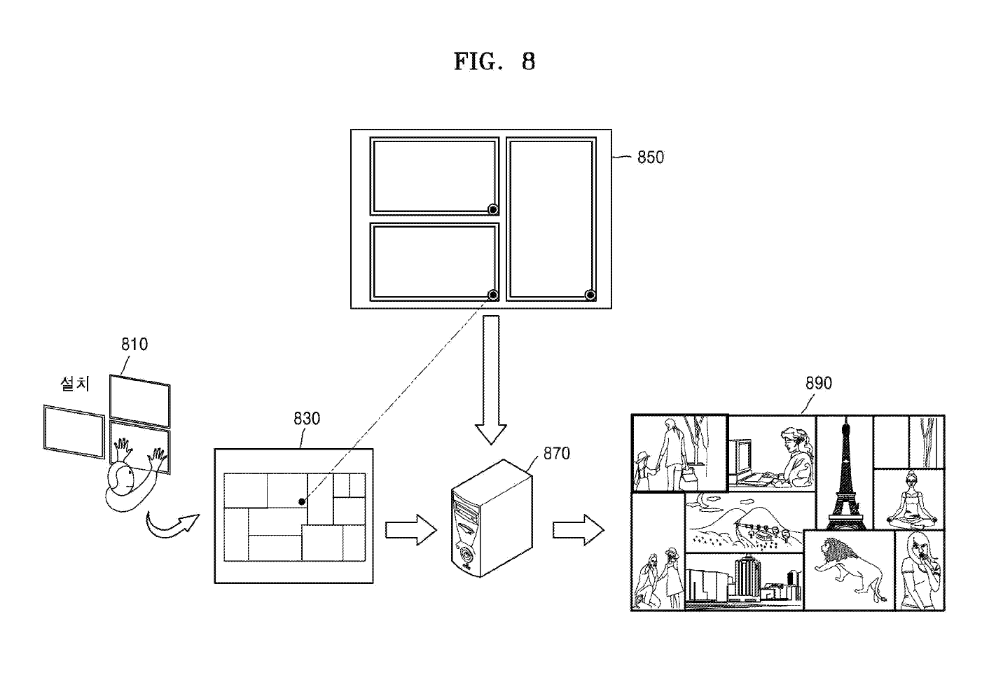

FIG. 8 is a flowchart illustrating an example method of installing a video wall.

In the current example, the method of installing a video wall includes: installing the video wall 810 and 830; obtaining arrangement information 870 of display apparatuses by receiving information 850 from sensors attached to the display apparatuses of the installed video wall; configuring a content 870 based on the obtained information; and transmitting the composed contents 890 to each of the display apparatuses.

The arrangement information of the display apparatuses received from the sensors attached to each of the display apparatuses may be more accurate than the arrangement information of the display apparatuses received from an image of the video wall captured by a photographing device.

For example, the information of separation distances between the display apparatuses and the inclination of the display apparatuses received from the sensors may be more accurate.

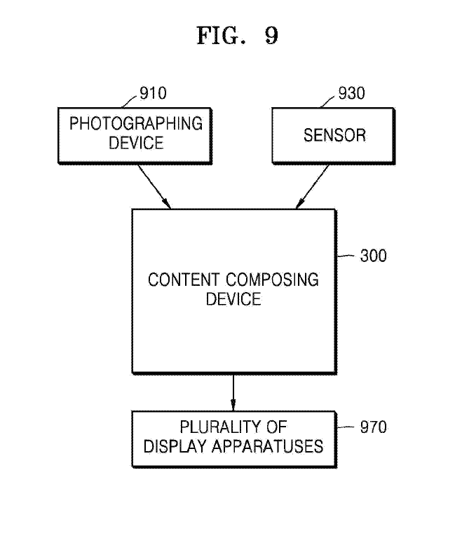

FIG. 9 is a block diagram illustrating an example process of receiving information from a photographing device 910 and a sensor 930.

The content composing device 300 according to an example may receive arrangement information of display apparatuses from both the photographing device 910 and the sensor 930.

In this case, some of the arrangement information received from the photographing device 910 and the sensor 930 may overlap.

When some of the arrangement information of the display apparatuses received from the photographing device 910 and the sensor 930 overlap, the arrangement information may be determined by applying different weighted values with respect to each of the arrangement information, and the arrangement information of the display apparatuses may be determined by adding the respective arrangement information.

In the current example, when it is known that the arrangement information of the display apparatuses overlap with each other, the arrangement information may be determined by prioritizing on one of the overlapping arrangement information. For example, the arrangement information that is given a low priority may not be used.

The content composing device 300 may compose contents to be displayed on each of the display apparatuses based on the obtained arrangement information of the display apparatuses and may transmit the composed contents 970 to each of the display apparatuses.

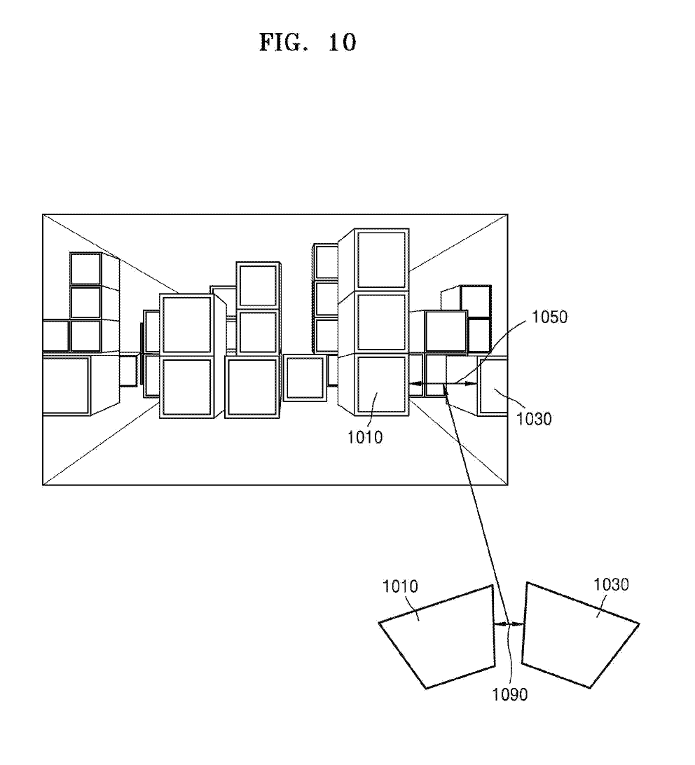

FIG. 10 is a drawing showing an example of gaining separation distances between display apparatuses.

In the video wall of FIG. 10, a display apparatus 1010 and a display apparatus 1030 are not connected to each other but are separated from each other. A distance between the display apparatuses 1010 and 1030 is referred to as a separation distance 1050.

The content composing device 300 may obtain separation distances 1050 between the display apparatuses from an image received from a photographing device.

When a captured image of the display apparatuses is received from the photographing device, the content composing device 300 may use a ratio correction method for calculating an actual separation distance 1050 based on a separation distance 1090 in the captured image in proportion to an actual size of the display apparatuses stored in advance and the size in the captured image.

However, the method of obtaining a separation distance from a received image is not limited thereto, that is, various methods may be used.

In the current example, the separation distance may be received from the sensors attached to the display apparatuses.

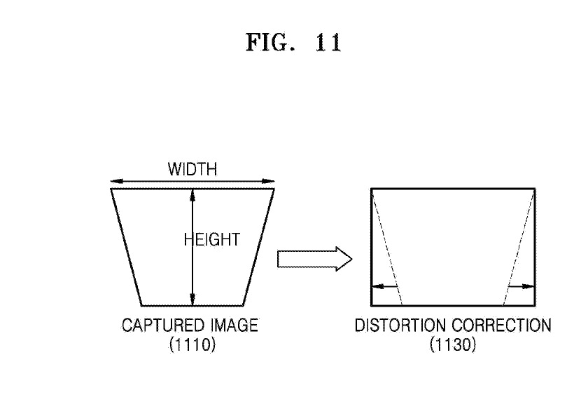

FIG. 11 is a schematic drawing showing an example correction of an image distortion based on photographing locations of a captured image by a content composing device.

When the photographing device takes a photograph of a video wall, an image distortion may occur based on photographing locations and angles.

For example, when an image 1130 of a display apparatus having a rectangular shape is captured from above the display apparatus, the image 1110 of the display apparatus may be seen as a trapezoidal shape in the captured image.

In this case, it may need to correct the image 1110 of the trapezoidal shape to the image 1130 of a rectangular shape.

For the correction of an image shape, the content composing device 300 may perform various processes of corrections including a vertical correction that corrects a distortion occurred when an image is captured above or below an object without taking a photo at the same height as the object; a horizontal correction that corrects a distortion occurred when an image is captured a left or right side of an object without taking a photo on a front side of the object; a rotational correction that corrects a distortion occurred when an image is captured at a state of a camera is inclined, etc.

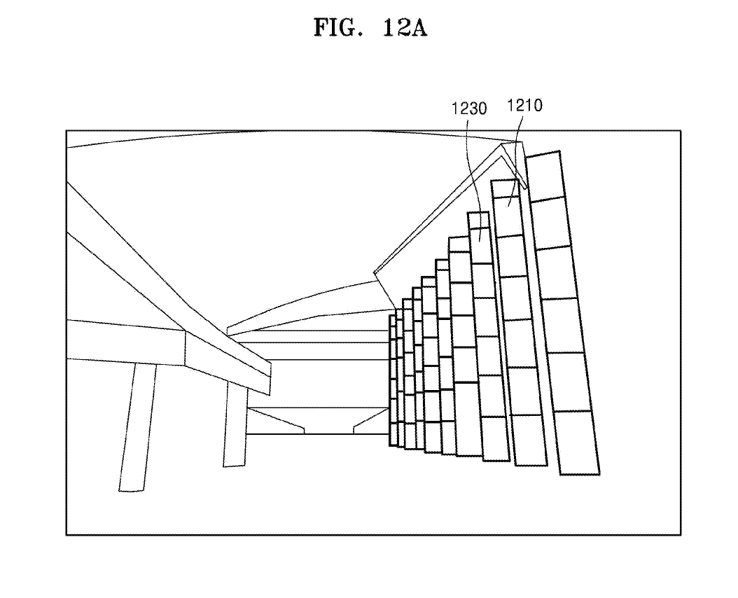

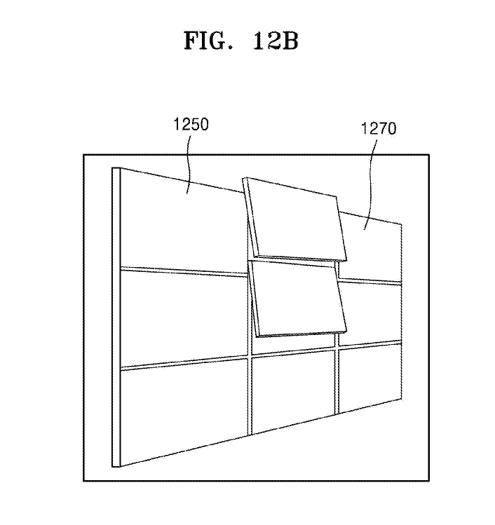

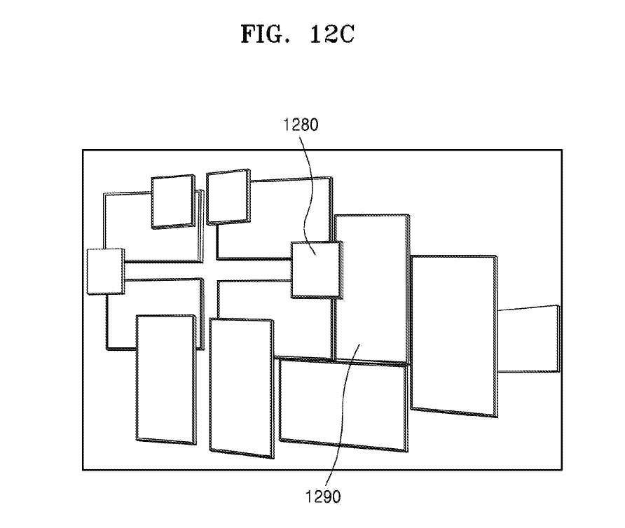

FIGS. 12A, 12B, and 12C are drawings explaining an example generation of a perspective distortion of an image.

FIG. 12A is a drawing of a video wall in which a display apparatus 1210 is relatively close to a photographing device and a display apparatus 1230 is relatively far from the photographing device.

FIG. 12B is a drawing of a video wall in which a display apparatus 1250 is relatively close to a photographing device and a display apparatus 1270 is relatively far from the photographing device.

FIG. 12C is a drawing of a video wall in which a portion of a display apparatus 1280 and a display apparatus 1290 overlap with each other.

The perspective distortions may occur based on a lens distortion, an angle of view, and photographing angle, and the perspective distortions may be corrected by using various methods or algorithms.

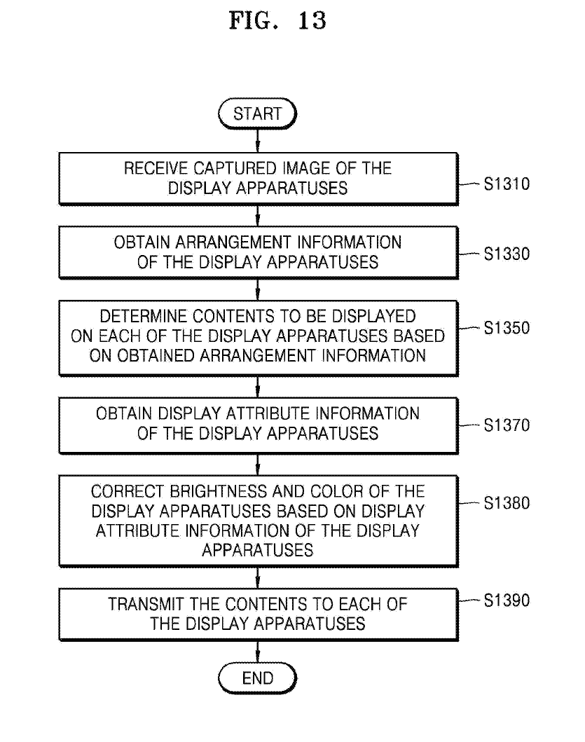

FIG. 13 is a flowchart illustrating an example method of composing content.

In operation S1310, the content composing device 300 may receive a captured image of a plurality of display apparatuses.

The captured image of the display apparatuses may, for example, be a single screen image of all display apparatuses that constitute a video wall.

In operation S1330, the content composing device 300 may obtain arrangement information of a plurality of display apparatuses.

The arrangement information of the display apparatuses may include at least one of the numbers, shapes and sizes, connection structures, locations, distances, inclinations, and separation distances of the display apparatuses.

The arrangement information of the display apparatuses may be obtained from an image of a video wall that is captured by a photographing device, such as a camera or a CCTV, from a sensor attached to each of the display apparatuses, or from other methods.

In operation S1350, the content composing device 300 may determine contents to be displayed on each of the display apparatuses based on the obtained information.

A video wall may repeatedly display the same content, but each of the display apparatuses may display a part of the whole content. In the case of a video wall in which each of the display apparatuses displays a part of the whole content, a process of determining contents to be displayed on each of the display apparatuses may be necessary since the display apparatuses display the contents by dividing the contents.

The contents to be displayed on each of the display apparatuses may be automatically determined based on the arrangement information of the display apparatuses.

In operation S1370, the content composing device 300 may obtain display attribute information of the display apparatuses.

The content composing device 300 may obtain display attribute information of the display apparatuses from a captured image received from a photographing device.

The display attribute information may include at least one of brightness and color of the display apparatuses.

In operation S1380, the content composing device 300 may correct the brightness and color of each of the display apparatuses based on the display attribute information of the display apparatuses.

The content composing device 300 may correct the content to be uniformly displayed by remote controlling a hardware register that is related to the display of the display apparatuses through software.

In operation S1390, the content composing device 300 may transmit generated contents to each of the display apparatuses.

The content composing device 300 may transmit generated contents to each of the display apparatuses through a wired or wireless network.

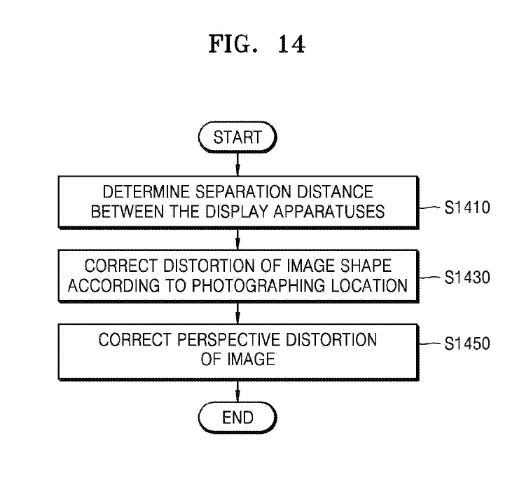

FIG. 14 is a flowchart illustrating an example method of obtaining information with respect to locations of display apparatuses.

When the content composing device 300 obtains arrangement information from a captured image, the arrangement information of the display apparatuses may be determined through the following processes.

In operation S1410, the content composing device 300 may determine separation distances between the display apparatuses.

In operation S1430, the content composing device 300 may correct the distortion of an image shape based on photographing locations.

In operation S1450, the content composing device 300 may correct perspective distortion of a received image.

According to an example, additional correction processes may further be performed.

FIG. 15 is a flowchart illustrating an example method of determining contents to be displayed on the display apparatuses.

In operation S1510, the content composing device 300 may obtain shape and size information of a layout in which the display apparatuses are connected based on the obtained arrangement information of the display apparatuses.

In operation S1530, the content composing device 300 may control the size of the content.

The content composing device 300 may control the size of the contents to fit the shape and size of the layout of the display apparatuses.

For example, a smaller size of the content may be displayed in the layout of FIG. 2B than in the layout of FIG. 2A.

The content composing device 300 may be configured to control the size of the contents to effectively display the contents while the whole content is included in the layout.

In operation S1550, the content composing device 300 may distribute the contents to the display apparatuses so that the content is located within the layout.

The content composing device 300 may distribute the contents to the display apparatuses to effectively display the contents while the whole content is included in the layout.

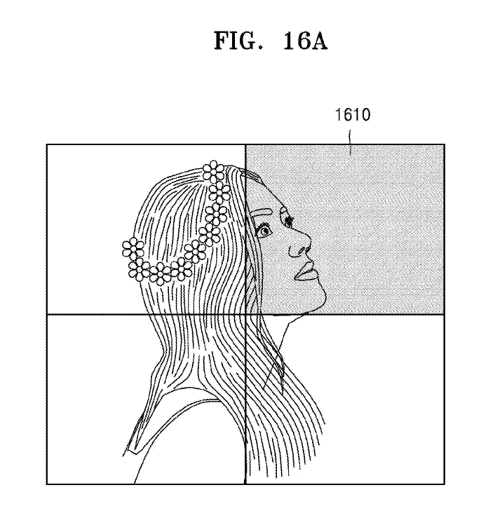

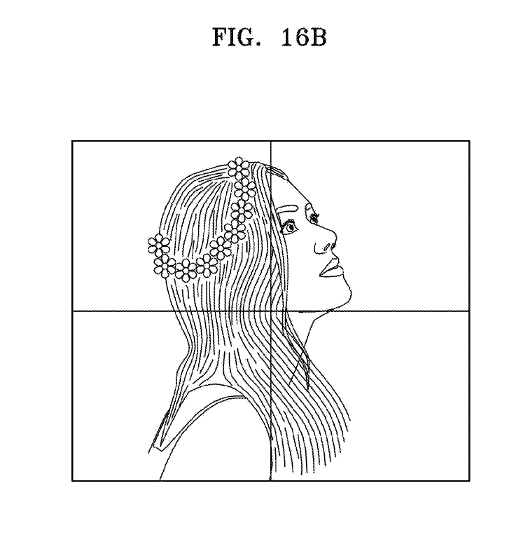

FIGS. 16A and 16B are drawings showing examples of correcting brightness and color of contents.

When a video wall is installed, there may be some differences in brightness and color when the contents is displayed based on the display attribute information of the display apparatuses, and thus, a process of correcting brightness and color may be needed.

FIG. 16A is a drawing showing a video wall before correcting brightness and color of the display apparatuses.

FIG. 16B is a drawing showing a video wall after correcting brightness and color of the display apparatuses.

The four display apparatuses used in FIG. 16A may have different apparatus information from each other, for example, manufacturers, manufacturing dates, and model names, etc.

Also, the four display apparatuses may have differences in the degree of expression with respect to a display setting although the apparatus information is the same.

FIG. 16A is a drawing showing one display apparatus 1610 of the four display apparatuses used in a video wall is not uniform with other display apparatuses in brightness and color.

The content composing device 300 may correct the contents so that the contents is uniformly displayed by remote controlling a hardware register that is related to the display of the display apparatuses through software by obtaining display attribute information of the display apparatuses based on a received image.

In the current example, display attribute information of the display apparatuses may be obtained by using pre-information of each of the display apparatuses. For example, the content composing device 300 may store information, such as, manufacturers, manufacturing dates, model names, and current display information of each of the display apparatuses in advance. The stored information may be periodically updated.

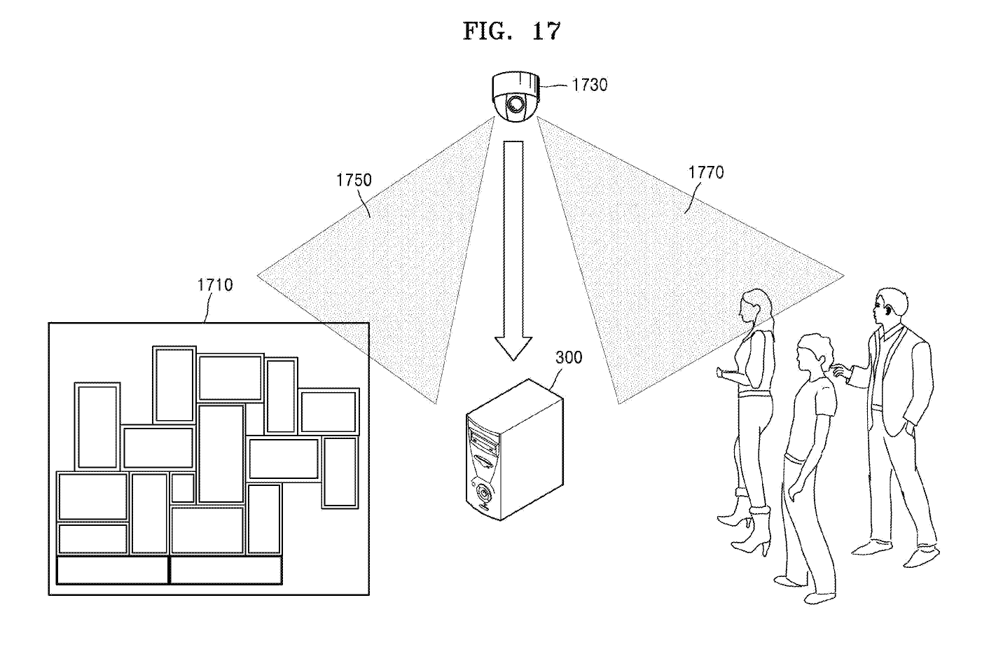

FIG. 17 is schematic drawing showing an example of obtaining information of a user through a photographing device.

The correction of brightness and color of the display apparatuses is necessary when a video wall is installed. Also, when a display state of the display apparatuses is continued for several hours, the displaying state of the display apparatuses may not be uniform. Thus, after the installation of the video wall is finished, the continued re-correction of brightness and color of the display apparatuses is needed.

In the related art, in order to correct brightness and color of the display apparatuses, a process of obtaining the display attribute and state information of each of the display apparatuses is manually performed by using a measuring instrument at times when there are no users.

According to the current example, the display attribute and state information of each of the display apparatuses may be obtained through a captured image of the video wall without using a measuring instrument, and thus, the convenience of operation is enhanced.

Also, instead of performing a re-correction work that is manually performed at times when there are no users, the re-correction work may be performed from time to time by receiving information about the presence of users through a photographing device 1730, such as a camera.

The photographing device 1730 may take a photograph 1750 of an image of a video wall 1710, and also, may take a photo 1771 of the presence of the users.

The content composing device 300 may perform a re-correction work of brightness and color of the display apparatuses from time to time through a captured image of a video wall based on the received information regarding the presence of users.

According to the current example, the re-correction of brightness and color of the display apparatuses may be periodically performed at a predetermined time.

The examples may also be embodied as computer readable codes on a computer readable recording medium. The computer readable recording medium is any data storage device that can store data which can be thereafter read by a computer system.

The codes that are readable by a computer are configured to perform operations that realize an image processing method according to an example when the codes are performed by reading the codes from the computer readable storage medium by a process. The computer readable codes may be realized in various programming languages. Also, functional programs, codes, and code segments for accomplishing the present invention can be easily construed by programmers skilled in the art to which the present invention pertains.

The computer readable storage medium includes read-only memory (ROM), random-access memory (RAM), CD-ROMs, magnetic tapes, floppy disks, optical data storage devices, and carrier waves (such as data transmission through the Internet). The computer readable recording medium may also be distributed over network coupled computer systems so that the computer readable code is stored and executed in a distributed fashion.

The embodiments are examples, and thus, it will be understood by those of ordinary skill in the art that various changes in form and details may be made therein without departing from the spirit and scope of the disclosure. Therefore, the examples should be considered in descriptive sense only and not for purposes of limitation. For example, each constituent element that is described as a singular form may be embodied in distribution forms. Also, constituent elements that are described in distribution forms may be embodied in a combined form.

Therefore, the scopes of the examples are defined not by the detailed description but by the appended claims, and all differences within the scope will be construed as being included in the examples.

What is claimed is:

1. A method of composing content to be displayed on a plurality of display apparatuses, comprising:
obtaining arrangement information of the display apparatuses from a captured image of the display apparatuses that display the content;
determining content to be displayed on each of the display apparatuses based on the obtained arrangement information; and
transmitting the content determined for each of the display apparatuses to the display apparatuses.

2. The method of claim 1, further comprising receiving the captured image of the display apparatuses from an external device.

3. The method of claim 1, further comprising:
obtaining display attribute information of the display apparatuses from a captured image of the display apparatuses; and
controlling the display apparatuses so that brightness and color of the display apparatuses are corrected based on the display attribute information of the display apparatuses.

4. The method of claim 1, further comprising obtaining arrangement information of the display apparatuses from sensors of each of the display apparatuses.

5. The method of claim 1, wherein the arrangement information comprises at least one of numbers, shapes, sizes, connection structures, locations, perspectives, inclinations, and separation distances of the display apparatuses.

6. The method of claim 1, wherein obtaining the arrangement information of the display apparatuses comprises correcting an image distortion based on a photographing location and perspective with respect to the captured image.

7. The method of claim 3, wherein the display attribute information of the display apparatuses comprises at least one of brightness information and color information of the display apparatuses.

8. The method of claim 3, further comprising:
receiving information about the presence of users based on a photograph; and
controlling the display apparatuses so that brightness and color of the display apparatuses are corrected based on the display attribute information of the display apparatuses based on the received information.

9. The method of claim 3, further comprising controlling each of the display apparatuses to periodically correct the brightness and color of the display apparatuses at predetermined times.

10. A content composing device that composes content to be displayed on display apparatuses, the content composing device comprising:
a processor configured to obtain arrangement information of the display apparatuses from a captured image of the display apparatuses that display the content and to determine the content to be displayed on each of the display apparatuses based on the obtained arrangement information; and
communication circuitry configured to transmit the content determined with respect to the display apparatuses to each of the display apparatuses.

11. The content composing device of claim 10, wherein the communication circuitry is configured to receive a captured image of the display apparatuses from an external device.

12. The content composing device of claim 10, wherein the processor is configured to obtain display attribute information of the display apparatuses from the captured image of the display apparatuses, and to control the display apparatuses so that brightness and color of the display apparatuses are corrected based on the display attribute information of the display apparatuses.

13. The content composing device of claim 10, wherein the communication circuitry is configured to receive arrangement information of the display apparatuses from sensors of the display apparatuses.

14. The content composing device of claim 10, wherein the arrangement information comprises at least one of numbers, shapes, sizes, connection structures, locations, perspectives, inclinations, and separation distances of the display apparatuses.

15. The content composing device of claim 10, wherein the processor is configured to correct an image distortion based on a photographing location and perspective with respect to the captured image of the display apparatuses.

16. The content composing device of claim 12, wherein the display attribute information of the display apparatuses comprises at least one of brightness information and color information of the display apparatuses.

17. The content composing device of claim 12, wherein the communication circuitry is configured to receive photographing information about the presence of users, and the processor is configured to control the display apparatuses so that brightness and color of the display apparatuses are corrected based on the display attribute information of the display apparatuses based on the received information.

18. The content composing device of claim 11, wherein the processor is configured to control each of the display apparatuses to periodically correct the brightness and color of the display apparatuses at predetermined times.

19. A non-transitory computer readable recording medium having recorded thereon a program for realizing the method of composing the content of claim 1.
